(19) United States
(12) Patent Application Publication
(10) Pub. No.: US 2005/0265622 A1
(43) Pub. Date: Dec. 1, 2005

(54) Contour emphasizing circuit for emphasizing contour of image

(75) Inventors: Katsumi Tokuyama, Osaka (JP); Keiichi Tsumura, Hyogo (JP); Michiko Shigemori, Hyogo (JP); Kenji Takahashi, Shiga (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO.LTD.

(21) Appl. No.: 11/136,544

(22) Filed: May 25, 2005

(30) Foreign Application Priority Data
May 25, 2004 (JP) P2004-154501

(51) Int. Cl. G06K 9/36; G06K 9/48

(52) U.S. Cl. 382/266; 382/199

(57) ABSTRACT

A contour emphasizing circuit according to the present invention comprises a line memory circuit 11 for retaining image data of each scanning line, an image data retaining circuit 12 comprised of a combination of delay elements for delaying the image data per pixel, a contour emphasizing signal generating circuit 13 for executing a coefficient operation with respect to a central pixel and peripheral pixels and generating a contour emphasizing signal S2, an image boundary detecting circuit 14 for detecting an image boundary portion separating effective and ineffective of the image data, and an input/output switching circuit 15 for switching between an input to the image data retaining circuit 12 from the line memory circuit 11 and an output of the image data retaining circuit with respect to the contour emphasizing signal generating circuit 13 based on a result of the detection of the image boundary detecting circuit 14.

### BACKGROUND OF THE INVENTION

1. Field of the Invention

The present invention relates to a technology for emphasizing a contour of an image in an image display device, an image pickup device and the like.

2. Description of the Related Art

A conventional technology of a contour emphasizing process is described referring to FIG. 10. A line memory circuit 31 comprises a plurality of line memories 31a and 31b. The line memories 31a and 31b respectively memorize and retain image data of a scanning line in an input image signal. An image data retaining circuit 32 includes a plurality of delay elements 32a-32f. The delay elements 32a-32f respectively delay the image data per pixel. A contour emphasizing signal generating circuit 33 includes a circuit 33a for generating a contour component signal and an adder 33b, and executes a coefficient operation with respect to central image data constituting a central part of an image and peripheral image data constituting a peripheral part of the image to thereby generate a contour emphasizing signal S2.

The contour component signal generating circuit 33a executes a process shown in FIG. 6. FIG. 6A shows an array of respective pixels P11, P12, P13, . . . , P33 constituting the image data. FIG. 6B shows an array of coefficients k1, k2, k3, . . . , k9, by which the arrayed pixels shown in FIG. 6A are multiplied. FIG. 6C shows the multiplication of the arrayed pixels of FIG. 6A by the coefficients of FIG. 6B and a contour component signal S1 constituting a total value of the multiplication result. The pixel P22 disposed in the center of FIG. 6A is a pixel of attention.

FIG. 11 is a timing chart in the case of emphasizing the contour on a horizontal scanning line. SH denotes a horizontal synchronous signal, SE1 denotes an inputted effective pixel region, and D13, D12 and D11 each denotes an image data value. Provided that D12 is the image data value of the pixel of attention P22, for example, D13 and D11 are respectively the image data values of the pixels P32 and P12 adjacent to the pixel P22.

The image data values D13, D12 and D11 respectively allocated to the pixels P32, P22 and P12 are multiplied by the coefficients k6, k5 and k4, and the contour component signal S1 is generated from the total of the multiplication values. The image data value of the pixel of attention P22 is added to the contour component signal S1 by the adder 33b, and a contour emphasizing signal S2 is thereby outputted.

The status shown FIG. 11 is collated with a filter region shown in FIG. 6, for example, at a timing t11. To provide a more specific description using numeral values, the arrayed coefficients are set as, k1=k2=k3=k7=k8=k9=0, and K4=−1, k5=2 and k6=−1. The image data D12 of the pixel of attention corresponds to the pixel P22. The image-data D13 preceding to the image data D12 by one pixel corresponds to the pixel P32, and the image data D11 behind the image data D12 by one pixel corresponds to the pixel P12. The contour component signal S1 results in the following.
(−1)×80h+2×80h+(−1)×0=80h

The contour emphasizing signal S2, which is obtained from the addition of the contour component signal S1 and the pixel of attention D12, results in the following.
80h+80h=FFh

The addition result is FFh as shown above in order to execute an eight-bit precision clip. The contour emphasizing signal S2 is thus increased at the timing t11.

The contour emphasizing signal S2 results in a large value also at a timing t14 because region data outside the image signal (black level signal) shows a value lower than the image signal, as a result of which the contour emphasizing signal S2 results in a value larger than previously intended (t15 and t16). More specifically, the data other than the image signal (D11 at the timing t11 and D13 at the timing t14) are judged to be black signals. Therefore, these signals (t15 and t16), which result in an unnaturally whitened image as the image signals when the contour emphasis is executed, cannot be used as effective signals. As a result, an actually usable output effective pixel is SA3.

FIG. 12 is a timing chart in the case of the contour emphasis in a vertical scanning line direction. SV denotes a vertical synchronous signal, SE2 denotes an inputted effective line region, and D23-D21 each denotes an image data value. In order to make it easy to understand the description, all the image data on one vertical scanning line are identical. For example, provided that D2 is a vertical scanning line of attention, D23 and D21 are vertical scanning lines adjacent to the line of attention. The, the contour component signal S1 is generated from these image data values, and the contour emphasizing signal S2 is outputted.

The status shown in FIG. 12 is collated with the filter region of FIG. 6, for example, at a timing t21. In this case, the array of coefficients are set as, k1=k3=k4=k6=k7=k9=0, and K2=−1, k5=2 and k8=−1. The image data D22 of the vertical scanning line of attention corresponds to the pixel P22. The image data D23 preceding to the image data D22 by one vertical scanning line corresponds to the pixel P23, and the image data D21 behind the image data D22 by one vertical scanning line corresponds to the pixel P21.

The result of adding the value of the contour component signal S1 and pixel of attention is FFh in order to execute the eight-bit precision clip. In the same manner, the contour emphasizing signal S2 results in a large value at a timing t22 because the black level signal shows a value lower than that of the image signal, as a result of which the contour emphasizing signal S2 results in a value larger than previously intended (t23 and t24). These pixels cannot be used as the effective signals because they result in the unnaturally whitened image as the image signals. The output effective pixel in the case of not using these pixels can be represented by SA4.

Showing the contents of the contour emphasizing process in an image signal chart, signals shown in FIG. 3B are obtained. At that time, signals 41a and 41b results in an excessively whitened image. Accordingly, the effective image signal, whose one pixel each in right, left, upper and lower directions is deleted therefrom, is outputted as the contour-emphasized signal as shown in FIG. 13V.

In the contour emphasizing process is also available a method in which a difference between the central part and the peripheral part in terms of a resolution of an image pickup lens is counterbalanced so as to obtain a substantially even resolution across an entire footage (for example, see the patent literature 1). However, the method, which utilizes a characteristic of the lens to correct the contour, fails to prevent the number of the pixels decreasing in the contour emphasizing process.

In the conventional technology, when the contour emphasizing process is executed to image data having an input image size by n pixels in an x direction and m pixels in a y direction, an output image size is by (n−2) pixels in the x direction and (m−2) pixels in the y direction. There is no particular problem in the foregoing case if the input image size is by equal to or more than (n+2) pixels in the x direction and equal to or more than (m+2) pixels in the y direction. However, an output format of an image sensor element is increasingly diversified along with an increasing number of pixels of the image sensor element, while a display size of the image signal ranges in a wider variety. To response to the ongoing change, a filtering process such as zooming may be necessarily executed in a pre-stage process. Accordingly, the input image size fails to satisfy the foregoing conditions in some cases, in which case the targeted size of the output image cannot be obtained making it not possible to use the contour emphasizing circuit.

### SUMMARY OF THE INVENTION

A contour emphasizing circuit according to the present invention comprises:
a line memory circuit for retaining image data of each scanning line;
an image data retaining circuit comprised of a combination of delay elements for delaying the image data per pixel;
a contour emphasizing signal generating circuit for executing a coefficient operation with respect to a central pixel constituting a central part of an image and peripheral pixels constituting a peripheral part of the image and generating a contour emphasizing signal;
an image boundary detecting circuit for detecting an image boundary portion separating effective and ineffective of the image data; and
an input/output switching circuit for switching between an input to the image data retaining circuit from the line memory circuit and an output of the image data retaining circuit with respect to the contour emphasizing signal generating circuit based on a result of the detection of the image boundary detecting circuit.

The input/output switching circuit is preferably adapted to extend an effective signal of a pixel boundary to an ineffective signal region of an adjacent pixel boundary based on a control of the image boundary detecting circuit.

The input/output switching circuit is preferably adapted to switch a read-out line when the image boundary detecting circuit detects an image boundary in a vertical direction and switch a read-out pixel when the image boundary detecting circuit detects an image boundary in a horizontal direction.

The image boundary detecting circuit detects the image boundary portion separating effective and ineffective of the image data to thereby control the input/output switching circuit. The input/output switching circuit is interposed between the line memory circuit and the image data retaining circuit and between the image data retaining circuit and the contour emphasizing signal generating circuit.

The input/output switching circuit, when detecting the image boundary in the horizontal direction, interpolates the image data of a pixel adjacent to a boundary outside an effective pixel region by the image data of a pixel adjacent to the boundary inside the effective pixel region, which is carried out on the boundary of the effective pixel region on both of right and left sides thereof. On the left-side boundary, an ineffective pixel next to a pixel of attention (effective pixel) on the left side is interpolated by the pixel of attention, while an ineffective pixel next to the pixel of attention (effective pixel) on the right side is interpolated by the pixel of attention on the right-side boundary.

The input/output switching circuit, when detecting the image boundary in the vertical direction, interpolates the image data of a line adjacent to the boundary outside the effective pixel region by the image data on a line adjacent to the boundary inside the effective pixel region, which is carried out on the boundary of the effective pixel region on both of upper and lower sides thereof. On the upper-side boundary, an ineffective line next to a line of attention (effective line) on the upper side is interpolated by the line of attention, while an ineffective line next to the line of attention (effective line) on the lower side is interpolated by the line of attention on the lower-side boundary.

More specifically, the ineffective signals (black level signal) immediately adjacent to the effective pixel region in the four directions thereof are interpolated by the effective signals adjacent thereto inside the effective pixel region. When the image signal, in which the ineffective signals immediately adjacent in the four directions are interpolated by the adjacent effective signals inside the effective pixel region, is inputted to the contour emphasizing signal generating circuit, the generation of an abnormal contour emphasizing component is prevented in the effective pixel region. Therefore, the output image contour-emphasized in the same size as the input image size can be generated.

The present invention can be realized without providing the input/output switching circuit.

More specifically, a contour emphasizing circuit according to the present invention comprises:
a line memory circuit for retaining image data of each scanning line;
an image data retaining circuit comprised of a combination of delay elements for delaying the image data per pixel;
a contour emphasizing signal generating circuit for executing a coefficient operation with respect to a central pixel and peripheral pixels and generating a contour emphasizing signal; and
an image boundary detecting circuit for detecting an image boundary portion separating effective and ineffective of the image data, wherein
the contour emphasizing signal generating circuit is adapted to execute an operation of the contour emphasis in such a state that a filter coefficient with respect to a line on an upper side of a line of attention is set to “0” when the image boundary detecting circuit detects an upper-side image boundary in a vertical direction, while a filter coefficient with respect to a line on a lower side of the line of attention is set to “0” when a lower-side image boundary is detected, and further, a filter coefficient with respect to a pixel on a left side of a pixel of attention is set to “0” when the image boundary detecting circuit detects a left-side image boundary in a horizontal direction, while a filter coefficient with respect to a pixel on a right side of the pixel of attention is set to “0” when a right-side image boundary is detected.

The filter coefficient is adjusted in the foregoing manner so that the ineffective signals (black level signal) immediately adjacent to the effective pixel region in the four directions thereof are interpolated by the effective signals adjacent thereto in the effective pixel region in the same manner as described earlier. The image signal, in which the ineffective signals immediately adjacent in the four directions are thus interpolated by the adjacent effective signals in the effective pixel region, is subjected to an operation process in the contour emphasizing signal generating circuit. As a result, the generation of the abnormal contour emphasizing component is prevented in the effective pixel region. Therefore, the output image contour-emphasized in the same size as the input image size can be generated.

Further, in another effective contour emphasizing circuit, the image boundary detecting circuit is controlled by an image size adjusting signal inputted from outside. More specifically, the image boundary detecting circuit is adapted to halt its action when the image size adjusting signal indicates an increase of number of pixels by two or an increase of number of lines by two relative to a standard.

The contour emphasizing circuit constituted in the foregoing manner can flexibly respond to such a case in which the image size is different depending on an enlarged magnification such as zooming or an output format of an image sensor element.

### BRIEF DESCRIPTION OF THE DRAWINGS

The present invention is illustrated be way of example and not limitation in the figures of the accompanying drawings, in which like references indicate similar elements and in which:

FIG. 1 is a block circuit diagram of an image pickup device;

FIG. 2 is a block circuit diagram of a contour emphasizing circuit according to a preferred embodiment 1 of the present invention;

FIG. 3 is a timing chart of a horizontal contour emphasizing process of the contour emphasizing circuit according to the embodiment 1;

FIG. 4 is a timing chart of a vertical contour emphasizing process of the contour emphasizing circuit according to the embodiment 1;

FIG. 5 is an illustration of an image signal (pixel data) in the contour emphasizing process of the contour emphasizing circuit according to the embodiment 1;

FIG. 6 is an illustration of a contour emphasizing signal;

FIG. 7 is a block diagram illustrating a constitution of a contour emphasizing circuit according to a preferred embodiment 2 of the present invention.

FIG. 8 is a block diagram illustrating a constitution of a contour emphasizing circuit according to a preferred embodiment 3 of the present invention;

FIG. 9 is a block diagram illustrating a constitution of a contour emphasizing circuit according to a modified example of the preferred embodiment 3;

FIG. 10 is a block diagram illustrating a constitution of a contour emphasizing circuit according to a conventional technology;

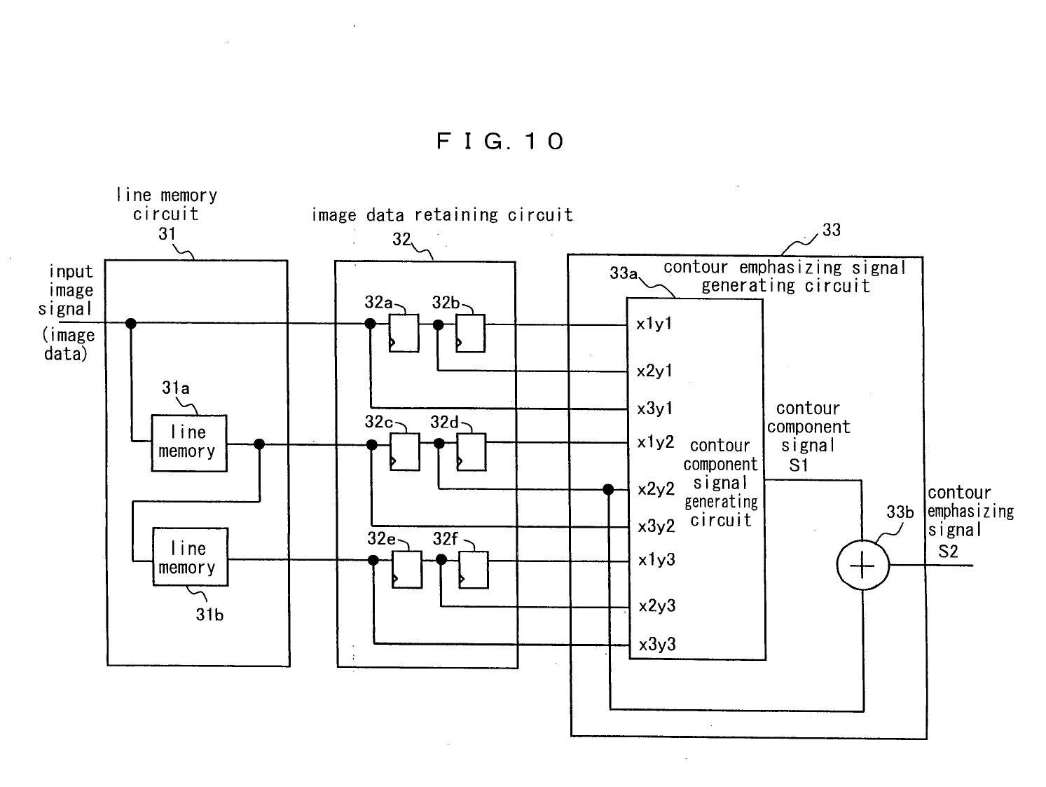

FIG. 11 is a timing chart of a horizontal contour emphasizing process of the contour emphasizing circuit according to the conventional technology;

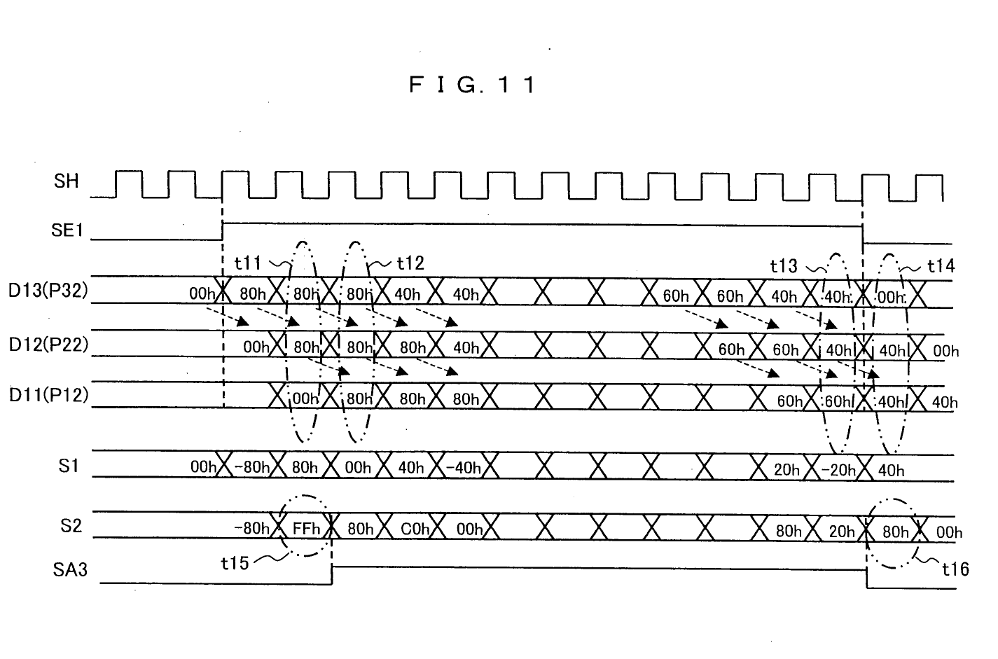

FIG. 12 is a timing chart of a vertical contour emphasizing process of the contour emphasizing circuit according to the conventional technology; and

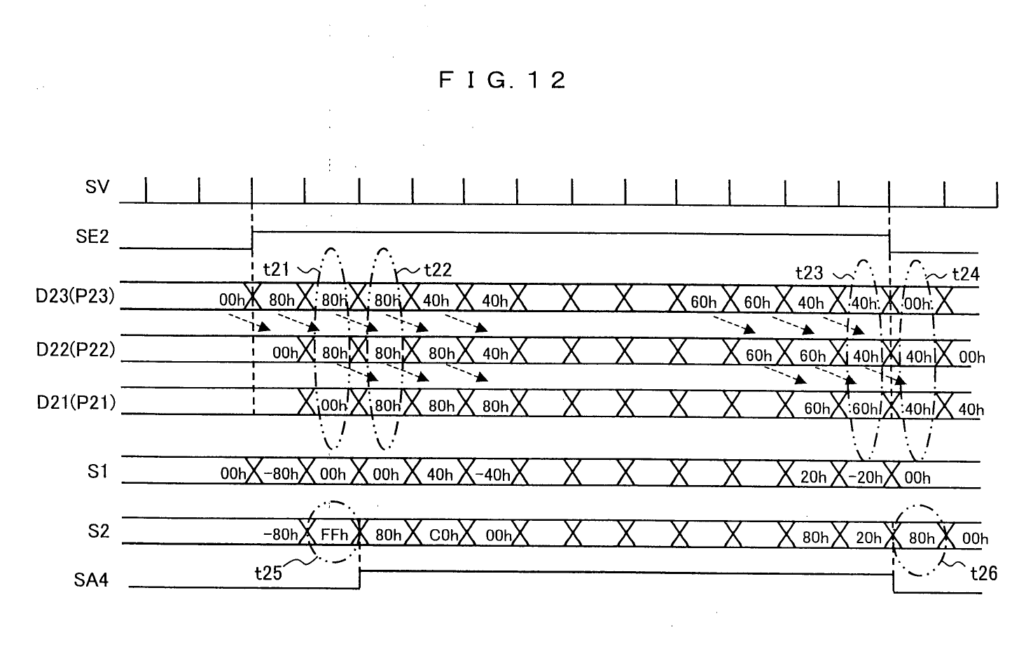

FIG. 13 is an illustration of an image signal (pixel data) in the contour emphasizing process of the contour emphasizing circuit according to the conventional technology.

### DETAILED DESCRIPTION OF THE PREFERRED EMBODIMENTS OF THE INVENTION

Hereinafter, a contour emphasizing circuit according to preferred embodiments of the present invention is described in detail-referring to the drawings.

### EMBODIMENT 1

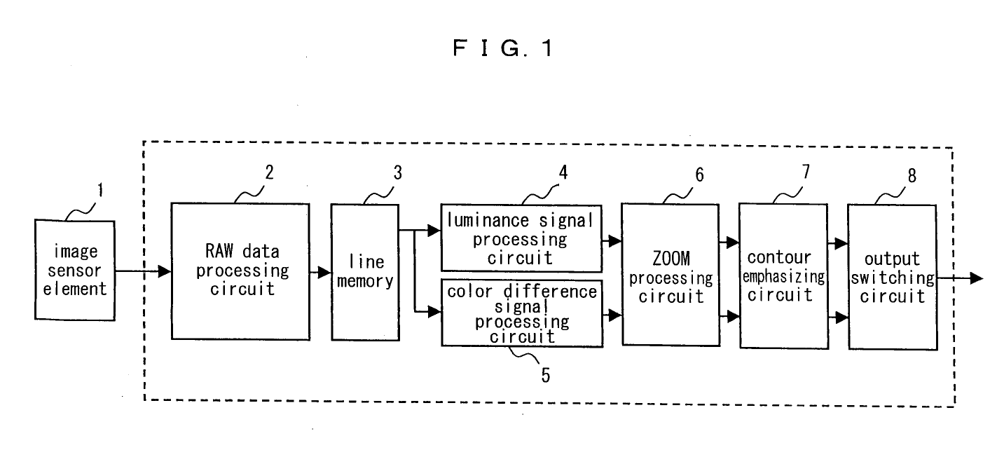

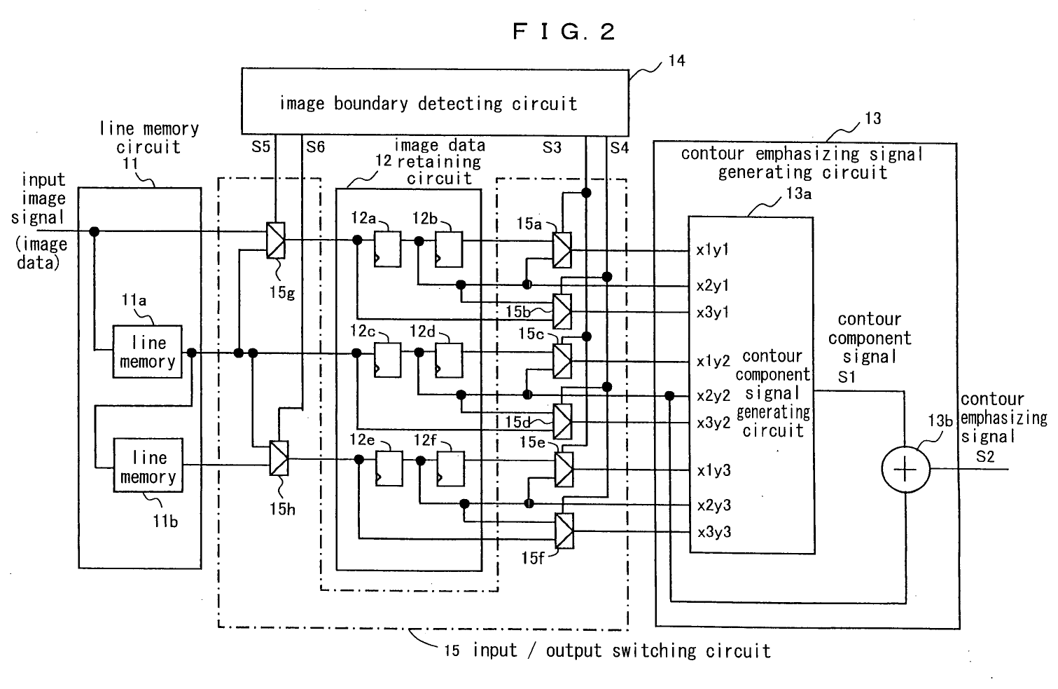

FIG. 1 is a block circuit diagram of an entire image pickup device. FIG. 2 is a block circuit diagram of a contour emphasizing circuit 7 shown in FIG. 1. Referring to reference numerals in FIG. 1, 1 denotes an image sensor element, 2 denotes a RAW data processing circuit for processing raw data (RAW data) which is unprocessed optical information received by the image sensor element 1, 3 denotes a line memory, 4 denotes a luminance signal processing circuit for processing a luminance signal, 5 denotes a color difference signal processing circuit for processing a color difference signal, 6 denotes a zoom processing circuit for enlarging (zooming) a part of a picked-up image in a digital process, 7 denotes a contour emphasizing circuit, and 8 denotes an output switching circuit. The constitution according to the preset embodiment exerts an effect with respect to the image sensor element having a fewer effective pixels or number of pixels being lessened in a pre-stage process of the contour emphasizing circuit 7. Further, the present invention can be implemented to the luminance signal processing circuit 4.

In the contour emphasizing circuit 7 shown in FIG. 2, a line memory 11 comprises a plurality of line memories 11a and 11b. The line memories 11a and 11b respectively memorize and retain image data in each scanning line of an input image signal (image data).

An image data retaining circuit (filter) 12 comprises a plurality of delay elements 12a-12f. The respective delay elements 12a-12f delay the image data per pixel which is a minimum unit of the image data.

A contour emphasizing signal generating circuit 13 comprises a contour component signal generating circuit 13a and an adder 13b. The contour emphasizing signal generating circuit 13 executes a coefficient operation with respect to a central pixel and peripheral pixels to thereby generate a contour emphasizing signal S2.

An image boundary detecting circuit 14 detects an image boundary portion separating effective and ineffective of the image data. The image boundary detecting circuit 14 outputs a selector control signal S3 when detecting a signal of a left-corner pixel constituting a left-corner part of the image, outputs a selector control signal S4 when detecting a signal of a right-corner signal constituting a right-corner part of the image, outputs a selector control signal S5 when detecting a signal of an upper-corner pixel constituting an upper-corner part of the image, and outputs a selector control signal S6 when detecting a signal of a lower-corner pixel constituting a lower-corner part of the image.

An input/output switching circuit 15 comprises a plurality of selectors 15a-15h and switches between an output of the line memory circuit 11 with respect to the image data retaining circuit 12 and an output of the image data retaining circuit 12 with respect to the contour emphasizing signal generating circuit 13 in response to the selector control signals S3-S6 outputted by the image boundary detecting circuit 14 as a detection result.

More specifically, the following action is executed in the input/output switching circuit 15 in response to the selector control signals S3-S6. The selector 15h selects an output of the line memory 11b when the selector control signal S6 is inactive, while selecting an output of the line memory 11a when the selector control signal S6 is active. The selector 15g selects the input image signal (image data) when the selector control signal S5 is inactive, while selecting the output of the line memory 11a when the selector control signal S5 is active. The selector 15f selects an input to the delay element 12e when the selector control signal S4 is inactive, while selecting an output of the delay element 12e when the selector control signal S4 is active. The selector 15e selects an output of the delay element 12f when the selector control signal S3 is inactive, while selecting the output of the delay element 12e when the selector control signal S3 is active. The selector 15d selects an input to delay element 12c when the selector control signal S4 is inactive, while selecting an output of the delay element 12c when the selector control signal S4 is active. The selector 15c selects an output of the delay element 12d when the selector control signal S3 is inactive, while selecting the output of the delay element 12c when the selector control signal S3 is active. The selector 15b selects an input to the delay element 12a when the selector control signal S4 is inactive, while selecting an output of the delay element 12a when the selector control signal S4 is active. The selector 15a selects an output of the delay element 12b when the selector control signal S3 is inactive, while selecting the output of the delay element 12a when the selector control signal S3 is active.

The input image signal (image data) is inputted to the line memory circuit 11, and inputted to the contour component signal generating circuit 13a from an input side of the input/output switching circuit 15 via output sides of the image data retaining circuit 12 and the input/output switching circuit 15. In the contour component signal generating circuit 13a, a predetermined operation is executed so as to generate a contour component signal S1. In the adder 13b, an image signal of a pixel of attention and the contour component signal S1 are added so as to generate and output a contour emphasizing signal S2.

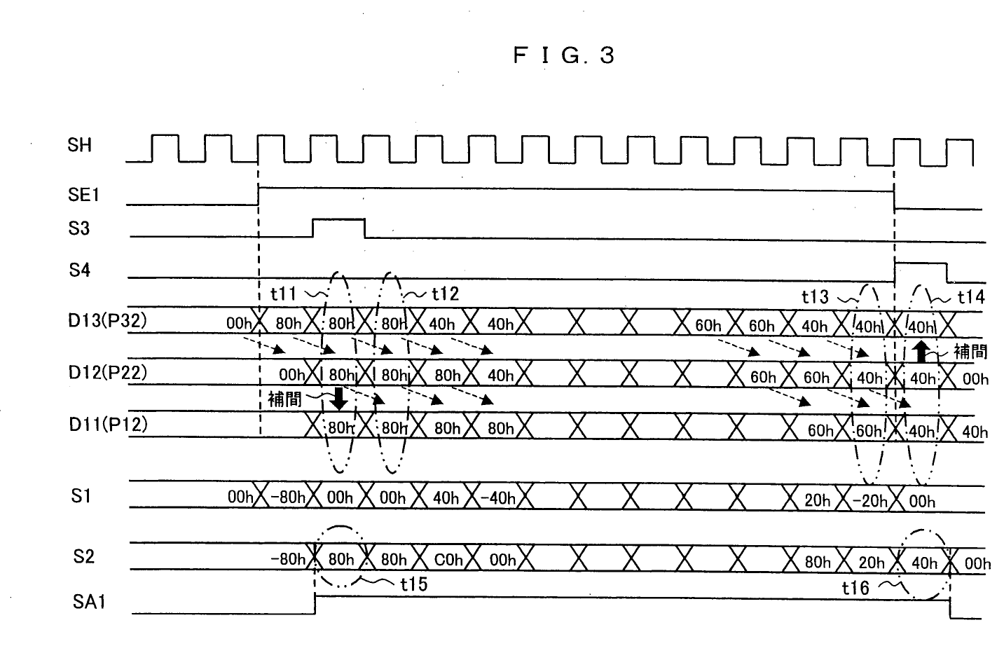

FIG. 3 is a timing chart in the case of the contour emphasis in a horizontal scanning line direction. SH denotes a horizontal synchronous signal, SE1 denotes an effective pixel region, D13, D12 and D11 each denotes an image data value. For example, provided that D12 is an image data value of a pixel of attention P22, D13 and D11 are respectively image data values of pixels P32 and P12 adjacent to the pixel D12. The contour component signal S1 is generated therefrom, and the contour emphasizing signal S2 is then generated and outputted.

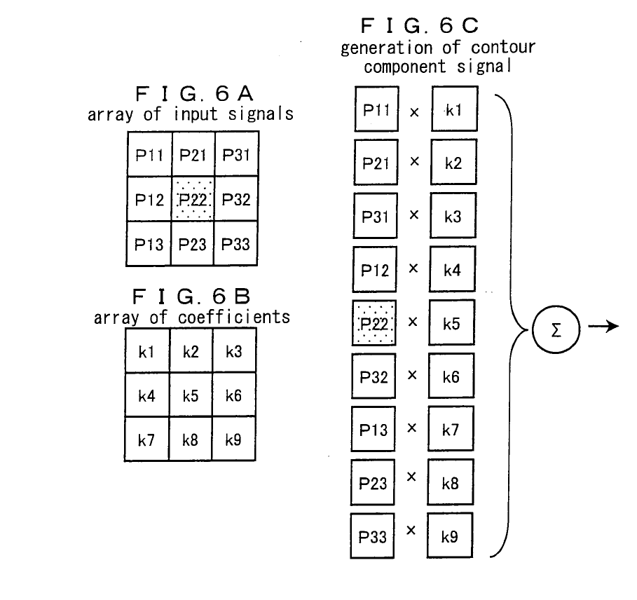

The status shown FIG. 3 is collated with a filter region shown in FIG. 6, for example, at a timing t11, in which case arrayed coefficients are set as, k1=k2=k3=k7=k8=k9=0, and K4=−1, k5=2 and k6=−1. The image data D12 of the pixel of attention corresponds to the pixel P22. The image data D13 preceding to the image data D12 by one pixel corresponds to the pixel P32, and the image data D11 behind the image data D12 by one pixel corresponds to the pixel P12.

The image boundary detecting circuit 14 sets the selector control signal S3 to an enable state at the timing t11 when detecting the signal of the left-corner pixel. Accordingly, the selector 15c is switched from the state of selecting the output of the delay element 12d up to then to the state of selecting the output of the delay element 12c. As a result, the image data D11 is interpolated by the image data D12 (see a downward arrow). At that time, the image data D11 is interpolated in such a manner that an ineffective signal is interpolated by the image data D12 of the boundary pixel inside the effective pixel region because the image data D12 corresponds to the boundary of effective pixels.

The image boundary detecting circuit 14 sets the selector control signal S4 to the enable state at a timing t14 when detecting the signal of the right-corner pixel. Accordingly, the selector 15d is switched from the state of selecting the input of the delay element 12c up to then to the state of selecting the output of the delay element 12c. As a result, the image data D13 is interpolated by the image data D12 (see an upward arrow). At that time, the image data D13 is interpolated in such a manner that the ineffective signal is interpolated by the image data D12 of the boundary pixel inside the effective pixel region because the image data D12 corresponds to the boundary of effective pixels.

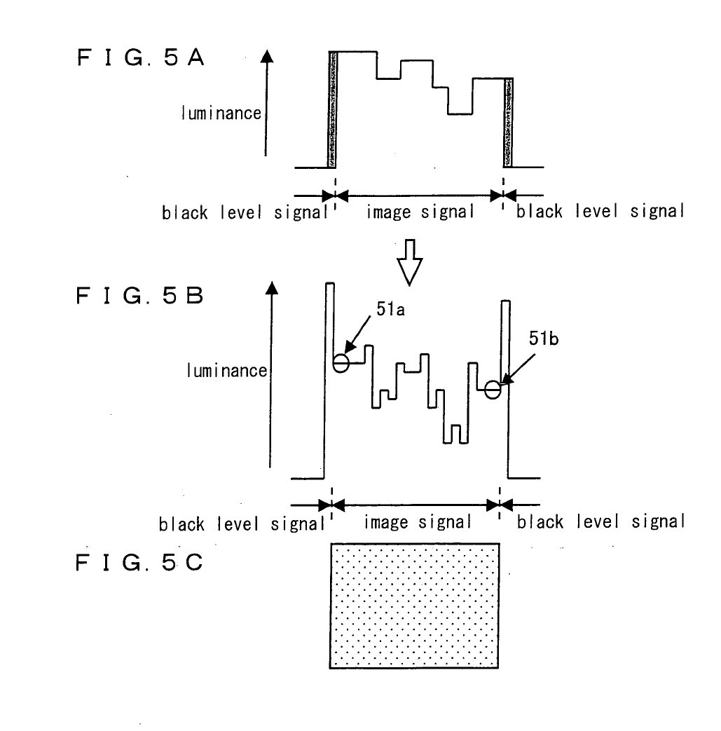

The image signal (image data) in the foregoing state is as shown in FIG. 5A. FIG. 5A shows the image signal (image data) prior to the contour emphasis, wherein black level signals are supplemented by pixels at both ends of an effective signal.

Then, generating the contour emphasizing signal S2 based on the arrayed coefficients as k4=−1, k5=2 and k6=−1, a high-frequency component is not detected because a signal of the pixel P12 is equivalent to the pixel P22 at the timing t11. Further, the high-frequency component is not detected because a signal of the pixel P32 is equivalent to the pixel P22 at a timing t14. In other words, there is no generation of an abnormal contour emphasizing component in the contour emphasizing signal S2. In the contour-emphasized image signal image data), a region represented by SA1 can be used as the effective signal.

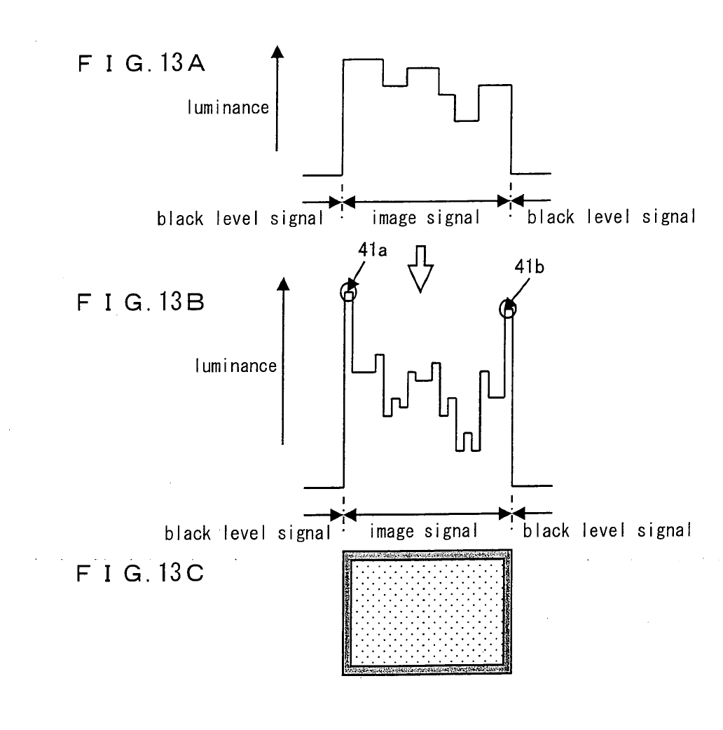

The image signal in the foregoing state is as shown in FIG. 5B, wherein the image signal becomes flat on the image boundary as indicated by 51a and 51b. In the contour-emphasized image signal shown in the drawing, the abnormal contour emphasizing components 41a and 41b are not generated in the effective pixel region as in the conventional technology shown in FIG. 13.

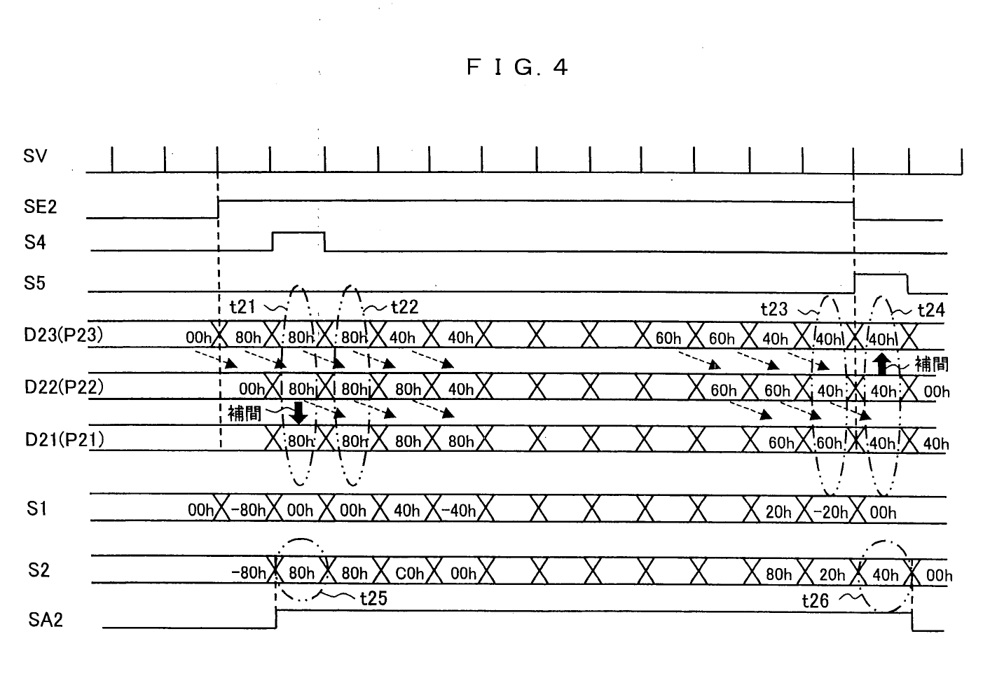

FIG. 4 is a timing chart in the case of the contour emphasis in a vertical scanning line direction. SV denotes a vertical synchronous signal, SE2 denotes an inputted effective line region and D23-D21 each denotes an image data value. In order to make it easy to understand the description, all of the image data on one line are identical. For example provided that D22 is a line of attention, D23 and D21 are lines adjacent to the line D22. The contour component signal S1 is generated therefrom, and the contour emphasizing signal S2 is thereby outputted.

The status shown FIG. 4 is collated with a filter region shown in FIG. 2, for example, at a timing t21, in which case the arrayed coefficients are set as, k1=k3=k4=k6=k7=k9=0, and K2=−1, k5=2 and k8=−1. The image data D22 of the line of attention corresponds to the pixel P22. The image data D23 preceding to the image data D22 by one line corresponds to the pixel P23, and the image data D21 behind the image data D22 by one line corresponds to the pixel P21.

The image boundary detecting circuit 14 sets the selector control signal S5 to the enable state at the timing t21 when detecting the signal of the upper-corner line. Accordingly, the selector 15g is switched from the state of selecting the input image signal (image data) up to then to the state of selecting the output of the line memory 11a. As a result, the image data D21 is interpolated by the image data D22 (see a downward arrow). At that time, the image data D21 is interpolated in such a manner that the ineffective signal is interpolated by the image data D22 of the boundary pixel inside the effective pixel region because the image data D22 corresponds to the boundary of effective lines.

Further, the image boundary detecting circuit 14 sets the selector control signal S6 to the enable state at a timing t24 when detecting the signal of the lower-corner line. Accordingly, the selector 15h is switched from the state of selecting the output of the line memory 11b up to then to the state of selecting the output of the line memory 11a. As a result, the image data D23 is interpolated by the image data D22 (see an upward arrow). At that time, the image data D23 is interpolated in such a manner that the ineffective signal is interpolated by the image data D22 of the boundary pixel inside the effective pixel region because the image data D22 corresponds to the boundary of effective lines.

Then, generating the contour emphasizing signal S2 based on the coefficients as k2=−1, k5=2 and k8=−1, the high-frequency component is not detected because a signal of the pixel P21 is equivalent to the pixel P22 at the timing t21. Further, the high-frequency component is not detected because a signal of the pixel P23 is equivalent to the pixel P22 at the timing t24. In other words, there is no generation of the abnormal contour emphasizing component in the contour emphasizing signal S2. In the contour-emphasized image signal image data), a region represented by SA2 can be used as the effective signal.

As described so far, when the contour emphasizing process in the horizontal scanning direction shown in FIG. 3 and the contour emphasizing process in the vertical scanning direction shown in FIG. 4 are executed, the image signal (image data) contour-emphasized with no abnormal contour emphasizing component being generated therein can be realized without reducing the effective pixel region. In the conventional technology shown in FIG. 13C, the ineffective region by an upper-side line and a lower-side line and a right-side pixel and a left-side pixel was generated with respect to the input image size. In the present embodiment, the contour-emphasized image signal (image data) can be obtained in the state in which the output image size and the input image size are equal to each other as shown in FIG. 5C.

### EMBODIMENT 2

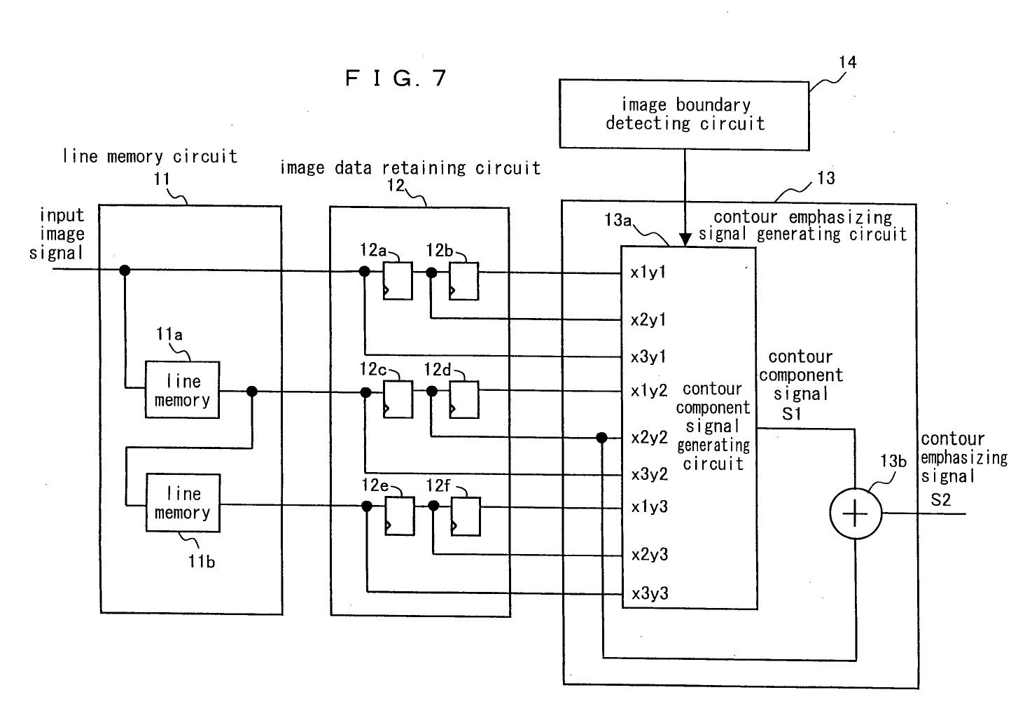

FIG. 7 is a block circuit diagram of a contour emphasizing circuit according to an embodiment 2 of the present invention.

In the embodiment 2, the input/output switching circuit 15 is not provided, and an image boundary detecting circuit 14 is adapted to control a filter coefficient of a contour component signal generating circuit 13a. The contour component signal generating circuit 13a is adapted to execute the operation of the contour emphasis in such a state that the filter coefficient with respect to the line on the upper side of the line of attention is set to “0” when the image boundary detecting circuit 14 detects an upper-side image boundary in the vertical direction, the filter coefficient with respect to the line on the lower side of the line of attention is set to “0” when the image boundary detecting circuit 14 detects a lower-side image boundary, the filter coefficient with respect to the pixel on the left side of the pixel of attention is set to “0” when the image boundary detecting circuit 14 detects a left-side image boundary in the horizontal direction, and the filter coefficient with respect to the pixel on the right side of the pixel of attention is set to “0” when the image boundary detecting circuit 14 detects a right-side image boundary. Any other structural element in the present embodiment corresponds to those in the constitution shown in FIG. 1. Therefore, the same structural elements are provided with the same reference symbol and not described here again.

The timing charts of FIGS. 3 and 4 are incorporated herein by reference.

At the timing t11 shown in FIG. 3, the image boundary detecting circuit 14 detects the signal of the left-corner pixel, and the contour component signal generating circuit 13a sets the array of coefficients as k4=0, k5=1 and k6=−1, while setting any other coefficient to “0” based on the detection result. As a result, the image data D11 is interpolated by the image data D12 (see the downward arrow). At that time, the image data D11 is interpolated in such a manner that the ineffective signal is interpolated by the image data D12 of the boundary pixel inside the effective pixel region because the image data D12 corresponds to the boundary of the effective pixels.

At the timing t14, the image boundary detecting circuit 14 detects the right-corner pixel, and the contour component signal generating circuit 13a sets the array of the coefficients as k4=−1, k5=1 and k6=0, while setting any other coefficient to “0” based on the detection result. As a result, the image data D13 is interpolated by the image data D12 (see the upward arrow). At that time, the image data D13 is interpolated in such a manner that the ineffective signal is interpolated by the image data D12 of the boundary pixel inside the effective pixel region because the image data D12 corresponds to the boundary of the effective pixels.

At the timing t21 in FIG. 4, the image boundary detecting circuit 14 detects the upper-corner line, and the contour component signal generating circuit 13a sets the array of the coefficients as k2=0, k5=1 and k8=−1, while setting any other coefficient to “0” based on the detection result. As a result, the image data D21 is interpolated by the image data D22 (see the downward arrow). At that time, the image data D21 is interpolated in such a manner that the ineffective signal is interpolated by the image data D22 of the boundary pixel inside the effective pixel region because the image data D22 corresponds to the boundary of the effective lines.

At the timing t24, the image boundary detecting circuit 14 detects the lower-corner line, and the contour component signal generating circuit 13a sets the array of the coefficients as k2=−1, k5=1 and k8=0, while setting any other coefficient to “0” based on the detection result. As a result, the image data D23 is interpolated by the image data D22 (see the upward arrow). At that time, the image data D23 is interpolated in such a manner that the ineffective signal is interpolated by the image data D22 of the boundary pixel inside the effective pixel region because the image data D22 corresponds to the boundary of the effective lines.

According to the embodiment 2, the array of the coefficients is switched over depending on whether or not the pixel of attention corresponds to the boundary. Therefore, an effect similar to that of the embodiment 1 can be exerted without providing the input/output switching circuit 15 for switching the selectors.

### EMBODIMENT 3

The embodiments 1 and 2 recite the method of emphasizing the contour without reducing the effective pixels provided that the input image size is by n pixels or (n+1) pixels in an x direction and m pixels or (m+1) pixels in a y direction when a standard output image size is by n pixels in the x direction and m pixels in the y direction.

In contrast to that, the conventional method does not cause any particular problem in the contour emphasis as far as the input image size is by (n+2) pixels or more in the x direction and (m+2) pixels or more in the y direction relative to the standard output image size, on which an embodiment 3 of the present invention is premised.

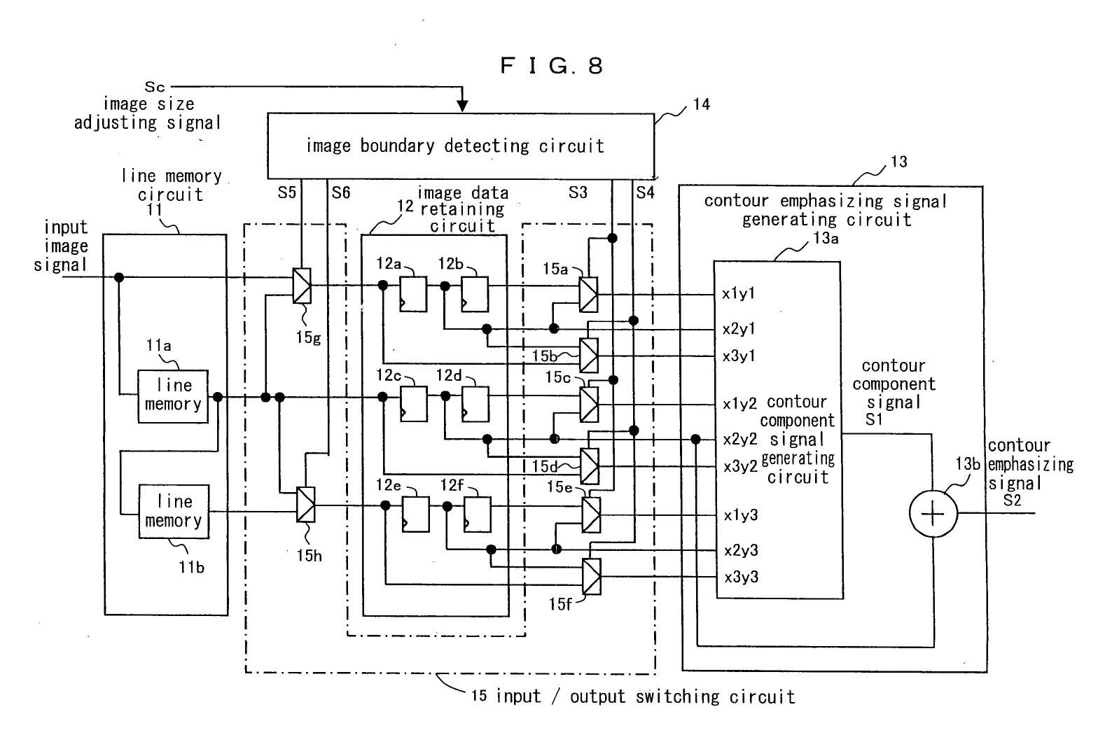

FIG. 8 is a block circuit diagram of a contour emphasizing circuit according to the embodiment 3. In the present embodiment, an image size adjusting signal Sc acting on the image boundary detecting circuit 14 is additionally provided. The image boundary detecting circuit 14 is adapted to halt its action when the image size adjusting signal Sc indicates the increase of the number of the pixels by two or increase of the number of the lines by two relative to the standard. When the action of the image boundary detecting circuit 14 is halted, the contour emphasizing circuit according to the present embodiment functions in the same manner as the conventional contour emphasizing circuit. Any other structural element in the present embodiment corresponds to those in the constitution shown in FIG. 1. Therefore, the same structural elements are provided with the same reference symbol and not described here again.

When the image size adjusting signal Sc indicates the increase of the number of the pixels by two or increase of the number of the lines by two relative to the standard, the action of the image boundary detecting circuit 14 is halted. More specifically, provided that the input image size is by n pixels or (n+1) pixels in the x direction and m pixels or (m+1) pixels in the y direction in the case of the standard output image size having n pixels in the x direction and m pixels in the y direction, the image boundary detecting circuit 14 is activated. On the contrary, the image boundary detecting circuit 14 halts its action in the case of the input image size is by (n+2) pixels or more in the x direction and (m+2) pixels or more in the y direction.

According to the embodiment 3, the effective pixel region is set to be larger than the output image size so as to emphasize the contour based on the actual effective data. In such a manner, the contour can be naturally emphasized without reducing the output image size. In other words, the contour emphasizing signal can be constantly generated in an optimum state.

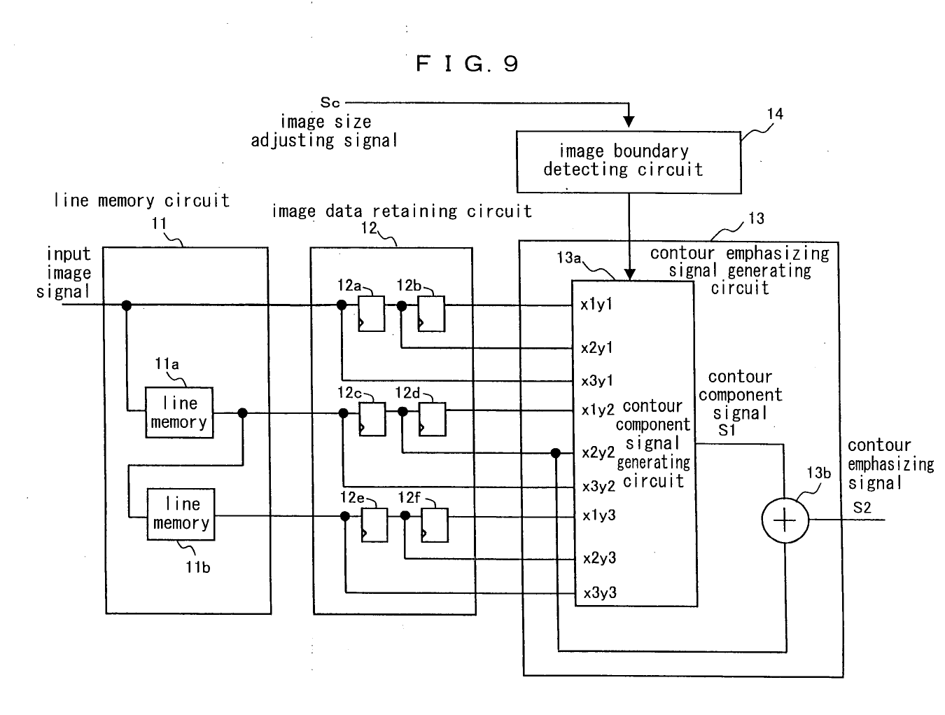

In the constitution shown in FIG. 7, the pixel boundary detecting circuit 14 may be adapted to execute the foregoing control operation in response to the image size adjusting signal Sc as shown in FIG. 9.

The basic embodiments were thus far described. In addition, the present invention can be implemented in the following modes.

1) In the described embodiments, the filter region has 3×3 pixels centered around the pixel of attention, in place of which the filter region may have 5×5 pixels. In that case, the same process is executed to two pixels each in the right, left, upper and lower directions of the image boundary.

2) In the case of the filter region having 5×5 pixels, the image size adjusting signal Sc is activated when the input image size is by (n+4) pixels or more in the x direction and (m+4) pixels or more in the y direction in the embodiment 3.

3) The embodiments can be applied to such a case that a filter region having an optional size of nx pixels×ny pixels is provided and an array of coefficients corresponding thereto are used.

4) The structural elements may be respectively realized by hardware or software, or may be realized in a hybrid manner using both the hardware and software.

While there has been described and illustrated in detail, it is to be clearly understood that this is intended be way of illustration and example only and is not to be taken by way of limitation, the spirit and scope of the present invention being limited only be the terms of the following claims.

1. A contour emphasizing circuit comprising:
a line memory circuit for retaining image data of each scanning line;
an image data retaining circuit comprised of a combination of delay elements for delaying the image data per pixel;
a contour emphasizing signal generating circuit for executing a coefficient operation with respect to a central pixel and peripheral pixels and generating a contour emphasizing signal;
an image boundary detecting circuit for detecting an image boundary portion separating effective and ineffective of the image data; and
an input/output switching circuit for switching between an input to the image data retaining circuit from the line memory circuit and an output of the image data retaining circuit with respect to the contour emphasizing signal generating circuit based on a result of the detection of the image boundary detecting circuit.

2. A contour emphasizing circuit as claimed in claim 1, wherein the input/output switching circuit extends an effective signal of a pixel boundary to an ineffective signal region of an adjacent pixel boundary based on a control of the image boundary detecting circuit.

3. A contour emphasizing circuit as claimed in claim 1, wherein the input/output switching circuit switches a read-out line when the image boundary detecting circuit detects an image boundary in a vertical direction and switch a read-out pixel when the image boundary detecting circuit detects an image boundary in a horizontal direction.

4. A contour emphasizing circuit as claimed in claim 1, wherein the image boundary detecting circuit is adapted to halt an action thereof when an image size adjusting signal inputted from outside shows an increase of number of pixels by two or an increase of number of lines by two relative to a standard.

5. A contour emphasizing circuit comprising:
a line memory circuit for retaining image data of each scanning line;
an image data retaining circuit comprised of a combination of delay elements for delaying the image data per pixel;
a contour emphasizing signal generating circuit for executing a coefficient operation with respect to a central pixel and peripheral pixels and generating a contour emphasizing signal; and
an image boundary detecting circuit for detecting an image boundary portion separating effective and ineffective of the image data, wherein
the contour emphasizing signal generating circuit is adapted to execute an operation of the contour emphasis in such a state that a filter coefficient with respect to a line on an upper side of a line of attention is set to “0” when the image boundary detecting circuit detects an upper-side image boundary in a vertical direction, while a filter coefficient with respect to a line on a lower side of the line of attention is set to “0” when a lower-side image boundary is detected, and further, a filter coefficient with respect to a pixel on a left side of a pixel of attention is set to “0” when the image boundary detecting circuit detects a left-side image boundary in a horizontal direction, while a filter coefficient with respect to a pixel on a right side of the pixel of attention is set to “0” when a right-side image boundary is detected.

6. A contour emphasizing circuit as claimed in claim 5, wherein the image boundary detecting circuit is adapted to halt an action thereof when an image size adjusting signal inputted from outside indicates an increase of number of pixels by two or an increase of number of lines by two relative to a standard.
